(19) United States
(12) Patent Application Publication
(10) Pub. No.: US 2012/0042352 A1
(43) Pub. Date: Feb. 16, 2012

(54) SET TOP BOX AND AUTO STANDBY METHOD THEREOF

(75) Inventors: FA-JIAN WANG, Shenzhen City (CN); ZHI-QIANG ZHANG, Shenzhen City (CN); XIAO-NI MA, Shenzhen City (CN)

(73) Assignees: HON HAI PRECISION INDUSTRY CO., LTD., Tu-Cheng (TW); AMBIT MICROSYSTEMS (SHANGHAI) LTD., SHANGHAI (CN)

(21) Appl. No.: 12/871,953

(22) Filed: Aug. 31, 2010

(30) Foreign Application Priority Data
Aug. 13, 2010 (CN) 201010253523.9

(51) Int. Cl. H04N 7/173

(52) U.S. Cl. 725/131

(57) ABSTRACT

A set top box transmits a connection request to a TV to request a number of response signals therefrom. The response signals are read when the TV is in a working state, and an idle signal is output if the response signals are not read in a predetermined time. State of the TV is determined according to the response signals or the idle signal, and the set top box is controlled to be in the working state according to the starting signal, or placed a sleeping/standby state according to the standby signal.

### BACKGROUND

1. Technical Field

The present disclosure relates to devices that process audio/video signals, and more particularly to a set top box and an auto standby method used in the set top box.

2. Description of Related Art

Set top boxes are a common way to control cable and satellite TV reception. Typically, set-top boxes can be manually put into a standby mode using a button on the box or on a remote control. However, manual operation of placing the set-top boxes in the standby mode makes it easy for users to forget, which results in wasted energy when the set-top box is not needed.

### BRIEF DESCRIPTION OF THE DRAWINGS

The details of the disclosure, both as to its structure and operation, can best be understood by referring to the accompanying drawings, in which like reference numbers and designations refer to like elements.

FIG. 1 is a schematic diagram illustrating one embodiment of an application environment of a set top box in accordance with an exemplary embodiment of the present disclosure.

FIG. 2 is a block diagram showing one embodiment of functional modules of the set top box of FIG. 1.

FIG. 3 is a flowchart of one embodiment of an auto standby method used in the set top box of FIG. 1.

### DETAILED DESCRIPTION

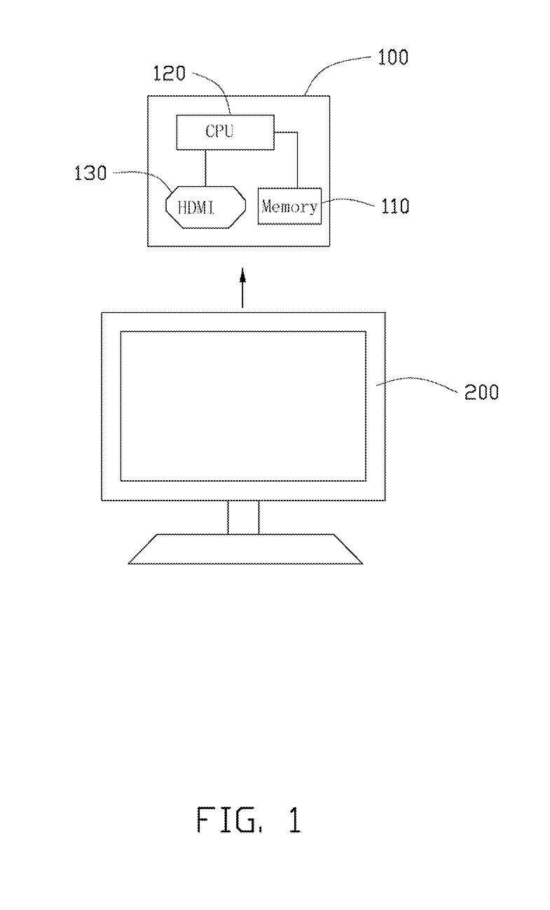

FIG. 1 is a schematic diagram illustrating one embodiment of an application environment of a set top box 100 in accordance with an exemplary embodiment of the present disclosure. The set top box 100 communicates with a television (TV) 200 when in use.

The set top box 100 includes a memory 110, one or more central processing units (CPUs) 120 electrically connected to the memory 110, and a High-Definition Multimedia Interface (HDMI) 130 embedded in the set top box 100 and connected to the memory 110. The TV 200 is coupled to the set top box 100 via an HDMI cable (not shown) plugged into the HDMI 130.

It is understood that the memory 110 may include volatile memory and may also include non-volatile memory, such as one or more magnetic disk storage devices, flash memory devices, or other non-volatile solid state memory devices. In the embodiment, the memory 110 includes non-volatile memory. The one or more CPUs 120 run various software programs and/or sets of instructions stored in the memory 110 to perform various functions for the set top box 100 and to process data. The HDMI 130 is connected to the TV 200 by an I²C Bus to transmit the data therein.

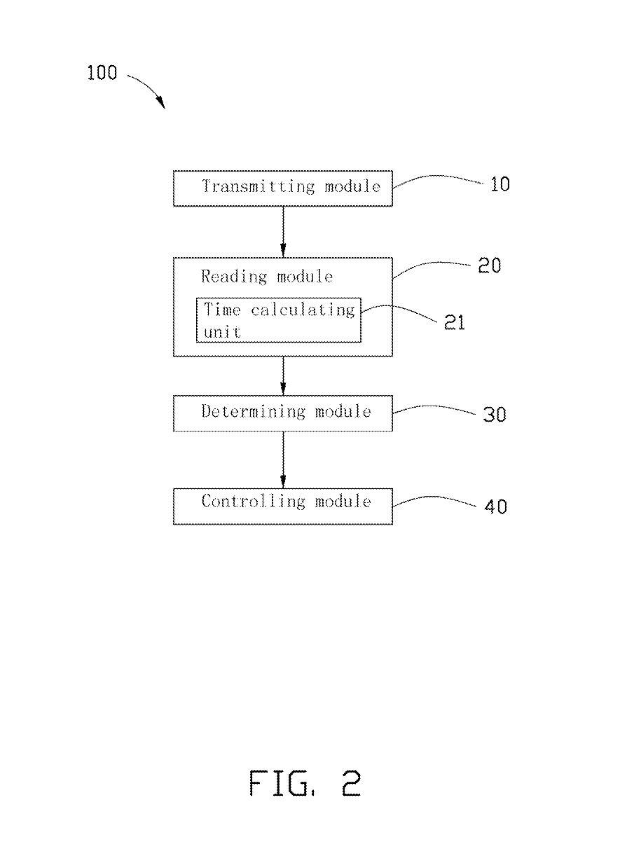

FIG. 2 is a block diagram showing the functional modules of the set top box 100 of FIG. 1. In the present embodiment, the set top box 100 includes a transmitting module 10, a reading module 20, a determining module 30, and a controlling module 40 stored in the memory 110. Note the modules 10-40 may comprise computerized code in the form of one or more programs that are stored in the memory 110. The computerized code includes instructions that are executed by the one or more CPUs 120 to provide corresponding functions for modules 10-40.

The transmitting module 10 periodically transmits a connection request to the TV 200 via the HDMI 130 and the HDMI cable, to request a number of response signals from the TV 200. In the present embodiment, the connection request may be transmitted at a predetermined time interval. Generally, when the TV 200 is in a working state, the TV 200 may feedback a number of response signals to the set top box 100. In the present embodiment, the response signals may be extended display identification data (EDID), which are standard Video Electronics Standards Association (VESA) data and includes strings of parameters of the TV 200, such as vendor information, maximum image size, color settings, manufacturers pre-setting, frequency range, name, and serial number, for example. Moreover, according to the I²C protocol, the EDID includes an acknowledgement (ACK) code when the TV 200 is in the working state. The EDID may be formatted to include a number of characters by placing the ACK code at a predetermined bit position in the EDID. In the present embodiment, when the TV 200 is in a working state, the predetermined bit position of the ACK code indicates a “1”. However, when the TV 200 is turned off or in a sleeping/standby state, the TV 200 may not respond to the connection request, and the predetermined bit position of the ACK code indicates a “0”.

The reading module 20 reads the response signals when the TV 200 is in a working state. When the reading module 20 does not receive the response signals in a predetermined time, that is, the TV 200 is turned off or in sleeping/standby state, the reading module 20 outputs an idle signal to the determining module 30. In the present embodiment, the reading module 20 includes a time calculating unit 21 that continuously calculates an idle time period during the time the reading module 20 does not receive the response signals. Furthermore, when the idle time period is equal to the predetermined time, the reading module 20 outputs the idle signal to the determining module 30.

The determining module 30 determines the state of the TV 200 according to the receipt of the response signals or the idle signal. In the present embodiment, the determining module 30 determines that the TV 200 is in working state when the reading module 20 receives the response signals, and determines that the TV 200 is turned off or in a sleeping/standby state when the reading module 20 receives the idle signal. In detail, the determining module 30 determines whether the ACK code is “1”, to determine the state of the TV 200. That is, if the ACK code is “1”, the determining module 30 determines the TV 200 is in working state, if the ACK code is “0”, the determining module 30 determines the TV 200 is turned off or in a sleeping/standby state. Furthermore, the determining module 30 outputs a starting signal to the controlling module 40 after determining the TV 200 is in working state, otherwise the determining module 30 outputs a standby signal to the controlling module 40.

The controlling module 40 controls the set top box 100 to remain in the working state if the starting signal is received, and places the set top box 100 in sleeping/standby state if the standby signal is received. As such, the set top box 100 can automatically go on standby. Note that the set top box 100 may be controlled by a software controller to switch between a working mode and a standby mode. The software controller may be, for example, a software or a control circuit, according to the starting signal or the standby signal input to the software controller. Specifically, when the set top box 100 is in the standby mode, the other functional modules (e.g. a video/audio processing module) except for the transmitting module 10, the reading module 20, the determining module 30, and the controlling module 40 of the set top box 100 are placed in the sleeping/standby state. As such, in spite of the set top box 100 being in the standby mode, the memory 110 and the CPU 120 can still work while the other functional modules of the set top box 100 are on standby.

Furthermore, the memory 110 stored with the transmitting module 10, the reading module 20, the determining module 30, and the controlling module 40 can be integrated in the set top box 100, or independent from the set top box 100 and electronically connected to the set top box 100.

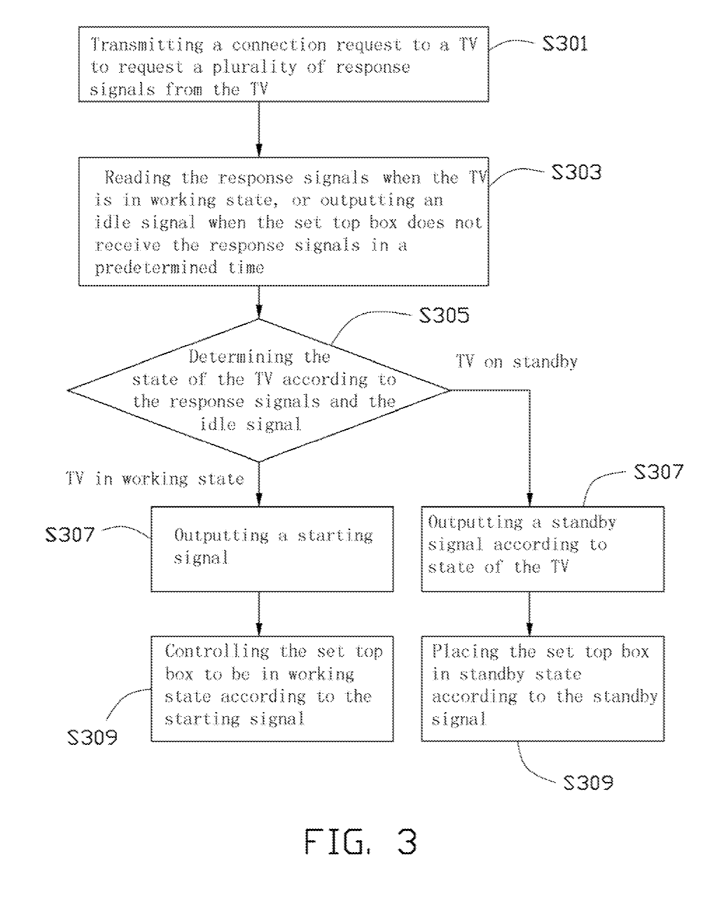

FIG. 3 is a flowchart of one embodiment of an auto standby method used in the set top box 100. Depending on the embodiment, additional steps may be added, others deleted, and the ordering of the steps may be changed.

In step S301, the set top box 100 periodically transmits a connection request to the TV 200, to request a number of response signals from the TV 200. In the present embodiment, the connection request may be transmitted at a predetermined time interval. Typically, when the TV 200 is in the working state, the TV 200 may feedback a number of response signals to the set top box 100. However, when the TV 200 is turned off or in sleeping/standby state, the TV 200 may not respond.

In step S303, the set top box 100 reads the response signals when the TV 200 is in the working state. When the reading module 20 does not receive the response signals in a predetermined time, the set top box 100 outputs an idle signal to the determining module 30. As mentioned previously, the time calculating unit 21 continuously calculates an idle time period during the time the set top box 100 does not receive the response signals. Also, when the idle time period is equal to the predetermined time, the set top box 100 outputs the idle signal.

In step S305, the set top box 100 determines the state of the TV 200 according to the response signals or the idle signal. In the present embodiment, the set top box 100 determines that the TV 200 is in the working state when receives the response signals, and determines that the TV 200 is turned off or in the sleeping/standby state when receives the idle signal.

In step S307, the set top box 100 outputs a starting signal or a standby signal according to state of the TV 200. In the present embodiment, the set top box 100 outputs a starting signal after determining the TV 200 is in the working state, or the set top box 100 outputs a standby signal after determining the TV 200 is turned off or in the sleeping/standby state.

In step S309, the set top box 100 controls specific functional modules of the set top box 100 to remain in a working state according to the starting signal, or places the special functional modules in sleeping/standby state according to the standby signal. Thus, state of the set top box 100 can be set according to receipt of the response signal or the idle signal. Specifically, according to the present embodiment, when the set top box 100 is in the standby mode, the other functional modules (e.g. a video/audio processing module) except for the transmitting module 10, the reading module 20, the determining module 30, and the controlling module 40 of the set top box 100 are placed in the sleeping/standby state. As such, in spite of the set top box 100 being in the standby mode, the memory 110 and the CPU 120 can still work while the other functional modules of the set top box 100 are on standby.

While various exemplary and preferred embodiments have been described, it is to be understood that the disclosure is not limited thereto. To the contrary, various modifications and similar arrangements (as would be apparent to those skilled in the art) are intended to also be covered. Therefore, the scope of the appended claims should be accorded the broadest interpretation so as to encompass all such modifications and similar arrangements.

What is claimed is:

1. A set top box, comprising:
a memory;
one or more central processing units; and
one or more modules stored in the memory and configured for execution by the one or more central processing units, the one or more modules comprising:
a transmitting module configured for transmitting a connection request to a TV to request a plurality of response signals from the TV;
a reading module configured for reading the response signals when the TV is in a working state, or outputting an idle signal when the reading module does not receive the response signals in a predetermined time; and
a controlling module configured for controlling the set top box to be in a working state according to receipt of the response signal, or placing the set top box in a standby state according to receipt of the idle signal.

2. The set top box of claim 1, wherein the connection request is transmitted at a predetermined time interval.

3. The set top box of claim 1, wherein the reading module comprises a time calculating unit for continuously calculating an idle time period during the time that the reading module does not receive the response signals, and when the idle time is equal to the predetermined time, the reading module outputs the idle signal to the determining module.

4. The set top box of claim 1, further comprising a determining module configured for determining the state of the TV according to the response signals or the idle signal, and further configured for outputting a starting signal according to the receipt of the response signals, or outputting a standby signal according to the receipt of the idle signal.

5. The set top box of claim 4, wherein the determining module determines that the TV is in a working state when the reading module receives the response signals, and determines that the TV is turned off or in a sleeping/standby state when the reading module receives the idle signal.

6. The set top box of claim 5, wherein the determining module determines whether an ACK code of the response signals is “1” to determine if the state of the TV is in the working state.

7. A set top box, comprising:
a memory;
one or more central processing units;
a High-Definition Multimedia Interface to communicate with a TV; and
one or more modules stored in the memory and configured for execution by the one or more central processing units, the one or more modules comprising instructions:
to periodically transmit a connection request to a TV via the High-Definition Multimedia Interface to request a plurality of response signals from the TV;
to read the response signals if the TV is in a working state, or to output an idle signal to if the set top box does not receive the response signals;
to determine the state of the TV according to the response signals or the idle signal, further to output a starting signal after receiving the response signals, or to output a standby signal after receiving the idle signal; and
to control the set top box to remain in a working state according to the starting signal, or to place the set top box in sleeping/standby state according to the standby signal.

8. An auto standby method used in a set top box, comprising the following steps:
transmitting a connection request to a TV to request a plurality of response signals from the TV;
reading the response signals when the TV is in a working state, or outputting an idle signal when the set top box does not receive the response signals in a predetermined time; and
controlling the set top box to remain in a working state according to receipt of the response signal, or placing the set top box in a standby state according to receipt of the idle signal.

9. The auto standby method claim 8, after the step of reading the response signals, the method further comprising: continuously calculating an idle time of the response signals, and when the idle time is equal to the predetermined time, outputting the idle signal.

10. The auto standby method of claim 8, wherein the method further comprises:
determining the TV is in a working state when the set top box receives the response signals, and determining the TV is turned off or in a sleeping/standby state when the set top box receives the idle signal.

11. The auto standby method of claim 10, wherein after the step of determining the TV is in the working state, the method further comprises: outputting a starting signal.

12. The auto standby method of claim 10, wherein after the step of determining the TV is in a sleeping/standby state, the method further comprises: outputting a standby signal.
